(19) United States
(12) Patent Application Publication
(10) Pub. No.: US 2009/0125516 A1
(43) Pub. Date: May 14, 2009

(54) SYSTEM AND METHOD FOR DETECTING DUPLICATE CONTENT ITEMS

(76) Inventors: Uri Schonfeld, Los Angeles, CA (US); Arnabnil Bhattacharjee, Santa Clara, CA (US); Rajat Ahuja, San Jose, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/939,834

(22) Filed: Nov. 14, 2007

(51) Int. Cl. G06F 17/30; G06F 15/18

(52) U.S. Cl. 707/6; 706/25; 707/E17.108

(57) ABSTRACT

Generally, the present invention provides systems, methods and computer program products for detecting different content items with similar content by examining the anchortext of the link. A method of the present invention comprises selecting one of a plurality of websites, crawling the selected website to identify one or more content items, and downloading one or more content items of the selected website. A determination is then made as to the one or more linking relationships from the one or more content items of the selected website and one or more linking rules are learned based upon association rule mining of the one or more content items. The one or more linking rules are then applied to one or more content items of one or more websites in order to determine storage of the one or more content items based upon the one or more linking rules on a search provider's central server.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to detecting duplicate content items. More specifically, embodiments of the present invention provide systems, methods and computer program products for detecting different content items with similar content by examining anchortext of a link to a given webpage.

### BACKGROUND OF THE INVENTION

A website is a collection of content items, images, videos or other digital content items that are hosted on one or more web servers, usually accessible via the Internet. A webpage is a document, typically written in HTML and accessible via HTTP, a protocol for transferring information from a web server for display in the web browser of a user. The content items of a website can usually be accessed from a common root URL called the homepage, and usually reside on the same physical server.

However, multiple content items of a website may be identical or nearly identical, and thus, duplicative content. For instance, a webpage on a website may be associated with several ancillary content items containing the same or similar content, such as webpage which contains the print version of the original webpage. When a search provider utilizes a search engine to generate a search result set, multiple content items of a website containing the same content may be responsive and thus provided as part of the search result set. The process of downloading multiple content items with duplicative content, however, results in wasted bandwidth, storage and CPU cycles for the search provider. Furthermore, current techniques that exist in the art to detect content items with duplicative content are costly and can only be accomplished after all content items of a website are downloaded, resulting in a temporal strain upon the storage resources, bandwidth and CPU cycles of a search provider.

Thus, there exists a need for systems, methods and computer program products for detecting different content items with similar content prior to the downloading of the content items.

### SUMMARY OF THE INVENTION

Generally, the present invention provides systems, methods and computer program products for detecting different content items with similar content by examining the anchortext of a link between two content items. A method of the present invention comprises selecting one of a plurality of websites, crawling the selected website to identify one or more content items of the selected website, and downloading one or more content items of the selected website. A determination is then made as to the one or more linking relationships from the one or more content items of the selected website and one or more linking rules are learned based upon association rule mining of the one or more content items of the selected website. The one or more linking rules are then applied to one or more content items of one or more websites in order to determine storage of the one or more content items of the one or more websites based upon the one or more linking rules on a search provider's central server.

By providing for the detection of multiple content items with similar content prior to the downloading of all content items of a given website, wasted bandwidth, storage and CPU cycles for the search provider are avoided. Specifically, if a search provider is able to limit the number of content items it downloads by precluding storage of multiple pages with duplicative content, bandwidth, storage and CPU cycles are conserved, as downloaded multiple content items providing duplicative content occupies a search provider's storage and bandwidth and frustrates a search provider's CPU cycles.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for detecting different content items with similar content by examining the anchortext of a link according to one embodiment of the present invention;

FIG. 2 illustrates a flow diagram presenting a method for learning one or more linking rules for detecting different content items with similar content by examining the anchortext of the link according to one embodiment of the present invention;

FIG. 3 illustrates a flow diagram presenting a method for applying one or more linking rules for detecting different content items with similar content by examining the anchortext of the link according to one embodiment of the present invention;

FIG. 4 illustrates a flow diagram presenting a method for learning one or more linking rules for detecting different content items with similar content by examining the anchortext of the link according to one embodiment of the present invention;

FIG. 5 illustrates a flow diagram presenting a method for learning one or more linking rules for detecting different content items with similar content by examining the anchortext of the link according to another embodiment of the present invention;

FIG. 6 illustrates a flow diagram presenting a method for learning one or more linking rules for detecting different content items with similar content by examining the anchortext of the link according to another embodiment of the present invention;

FIG. 7 illustrates a flow diagram presenting a method for applying one or more linking rules for detecting different content items with similar content by examining the anchortext of the link according to one embodiment of the present invention;

FIG. 8 illustrates a flow diagram presenting a method for applying one or more linking rules for detecting different content items with similar content by examining the anchortext of the link according to another embodiment of the present invention; and

FIG. 9 illustrates a flow diagram presenting a method for applying one or more linking rules for detecting different content items with similar content by examining the anchortext of the link according to another embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

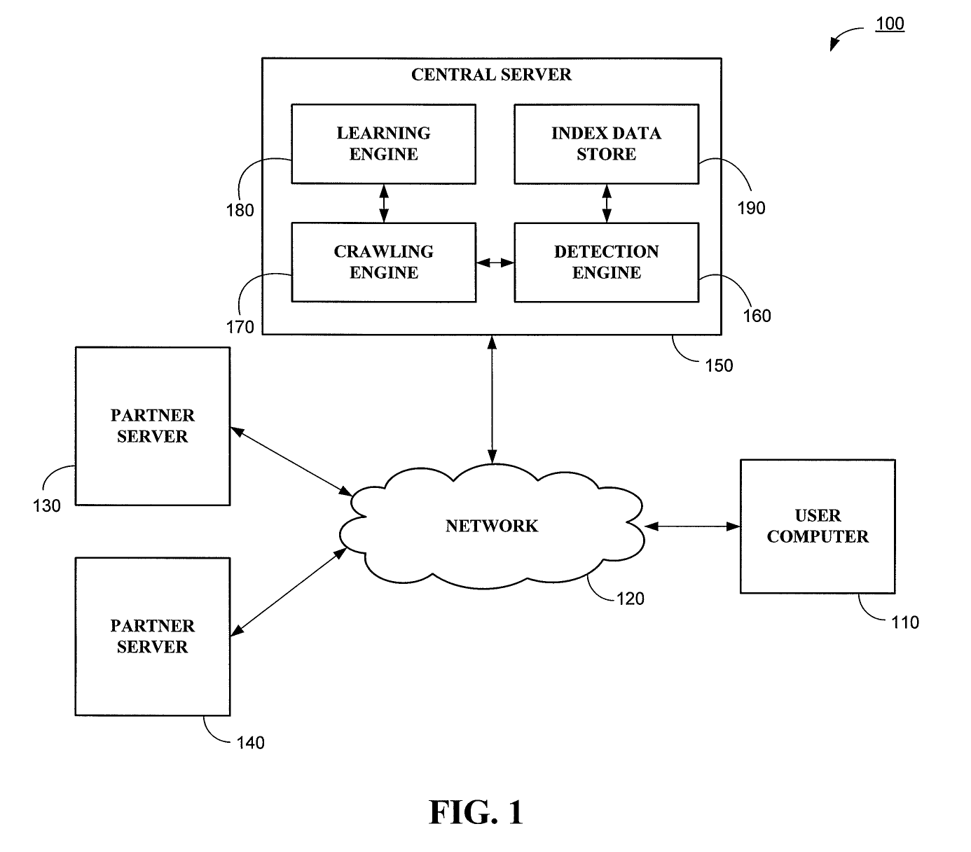

FIG. 1 illustrates one embodiment of a system for detecting different content items with similar content 100 that includes one or more clients 110, a computer network 120, one or more partner servers 130 and 140, and a central server 150. The central server 150 comprises a detection engine 160, a crawling engine 170, a learning engine 180 and an index data store 190.

The computer network 120 may be any type of computerized network capable of transferring data, such as the Internet. According to one embodiment of the invention, a given client device 110 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

According to one embodiment of the invention, the partner servers 130 and 140 and the central server 150 may be programmable processor-based computer devices that include persistent and transient memory, as well as one or more network connection ports for transmitting and receiving data on the network 120. Both the central server 130 and the partner servers 130 and 140 may host websites, store data, serve ads, etc. Those of skill in the art understand that any number and type of central server 130, partner servers 130 and 140, and user computer 110 may be connected to the network 120.

The detection engine 160, the crawling engine 170 and the learning engine 180 may comprise one or more processing elements operative to perform processing operations in response to executable instructions, collectively as a single element or as various processing modules, which may be physically or logically disparate elements. The index data store 190 may be one or more data storage devices of any suitable type, operative to store corresponding data therein. Those of skill in the art recognize that the central server 150 may utilize more or fewer components and data stores, which may be local or remote with regard to a given component or data store.

The central server 150 may utilize the one or more terms comprising a given query to identify content items, such as web pages, video clips, audio clips, documents, etc., that are responsive to the one or more terms comprising the query. The central server 150 uses communication pathways that the network 120 provides to access one or more partner severs, such as the first partner server 130 and the second partner sever 140, in order to locate content items that are responsive to a given query. Subsequently, the central server 150 may download the content items in the index data store 190 and provide a search result listing associated with the downloaded content items to the user computer 110 through the network 120.

According to one embodiment, the central server 150 maintained by a search provider may utilize one or more linking rules in order to avoid the downloading of content items with similar content. The central server 150 accomplishes this by first learning one or more linking rules. The central server 150 may select one of a plurality of websites offered by a partner server, such as partner server 130 or partner server 140. The crawling engine 170 of the central server 150 may then crawl the selected website to identify and download one or more content items of the selected website. The one or more content items are then passed to the learning engine 180 where one or more linking relationships are determined by association rule mining of the one or more content items that the selected website hosts. On the basis of the association rule mining, the learning engine 180 then learns one or more linking rules.

According to one embodiment, the central server 150 applies the one or more learned linking rules during the crawling of a subsequent web site. The crawling engine 170 may then crawl the one or more websites in order to identify one or more content items of the one or more websites. The detection engine 160 of the central server 150 may then apply the one or more linking rules learned by the learning engine 180 to the one or more content items of the one or more websites in order to identify one or more content items of a given website that have similar content. Utilizing the one or more linking rules, the detection engine 160 downloads and stores only one of the one or more content items of a given website that the detection engine 160 identifies as having similar content. The central server 150 may then store in the index data store 190 only those content items that are not duplicates.

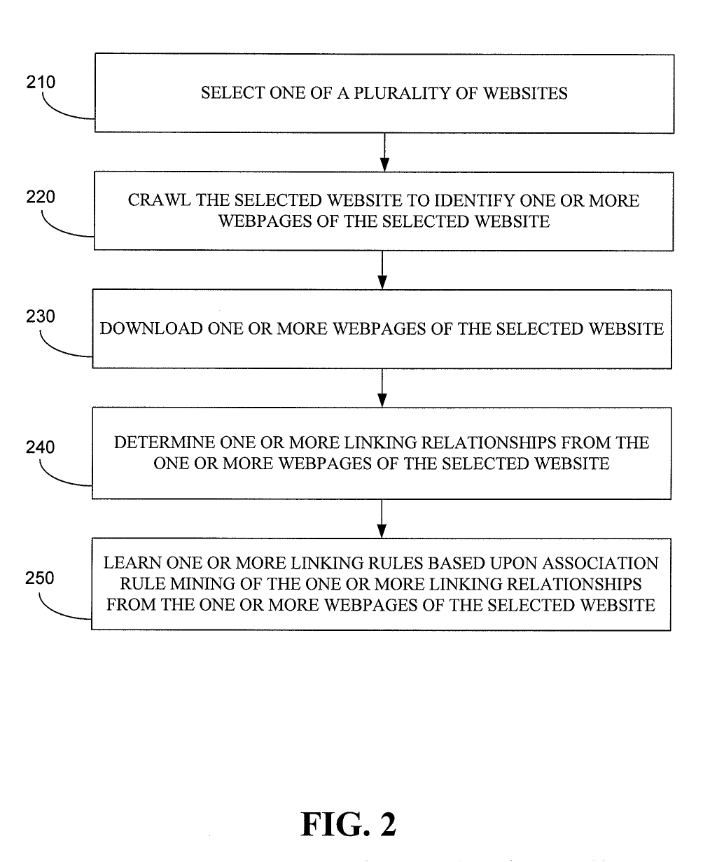

FIG. 2 illustrates a flow diagram presenting a method for learning one or more linking rules for detecting different content items with similar content by examining the anchortext of the link according to one embodiment of the present invention. In accordance with the embodiment of FIG. 2, the method may begin by selecting one of a plurality of websites, step 210, and crawling the selection website to identify one or more content items of the selected website, step 220. The one or more content items of the selected website are then downloaded, step 230, to determine one or more linking relationships between the one or more content items of the selected website, step 240. One or more linking rules are then learned on the basis of association rule mining of the one or more content items of the selected website, step 250. Exemplary embodiments of the method illustrated in FIG. 2 are described in greater detail below.

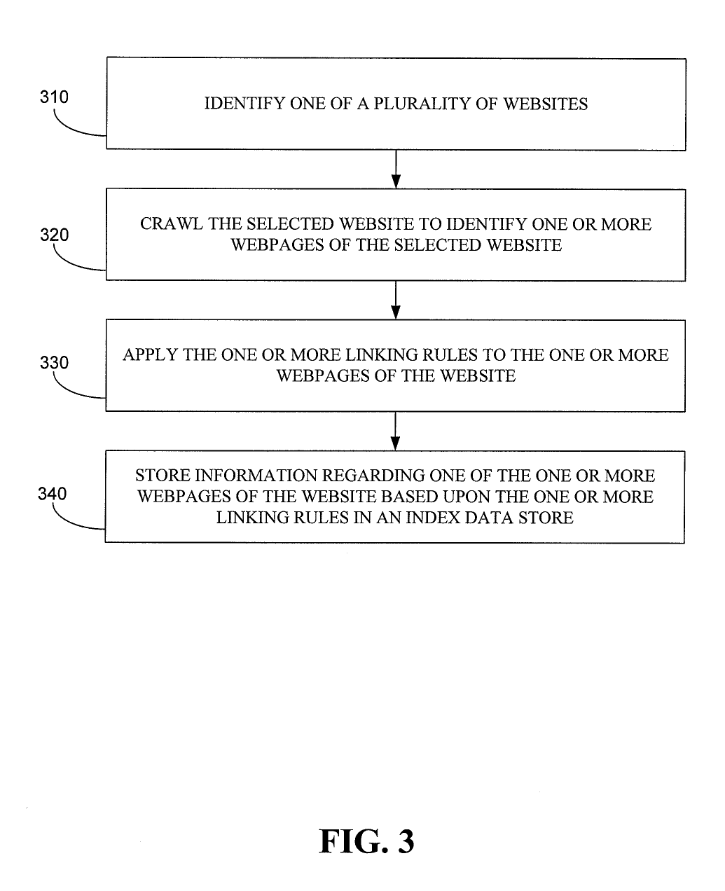

FIG. 3 illustrates a flow diagram presenting a method for learning one or more linking rules for detecting different content items with similar content by examining the anchortext of the link between content items according to one embodiment of the present invention. In accordance with the embodiment of FIG. 3, the method may begin by identifying one of a plurality of websites, step 310. The website may be crawled to identify one or more content items of the selected website, step 320. One or more linking rules are then applied to the one or more content items of the website, step 330, to identify those disparate content items with similar or identical content on the basis of the anchortext of links that link the disparate content items. Information regarding one of the one or more content items of the website is stored in an index data store on the basis of the one or more linking rules, step 340.

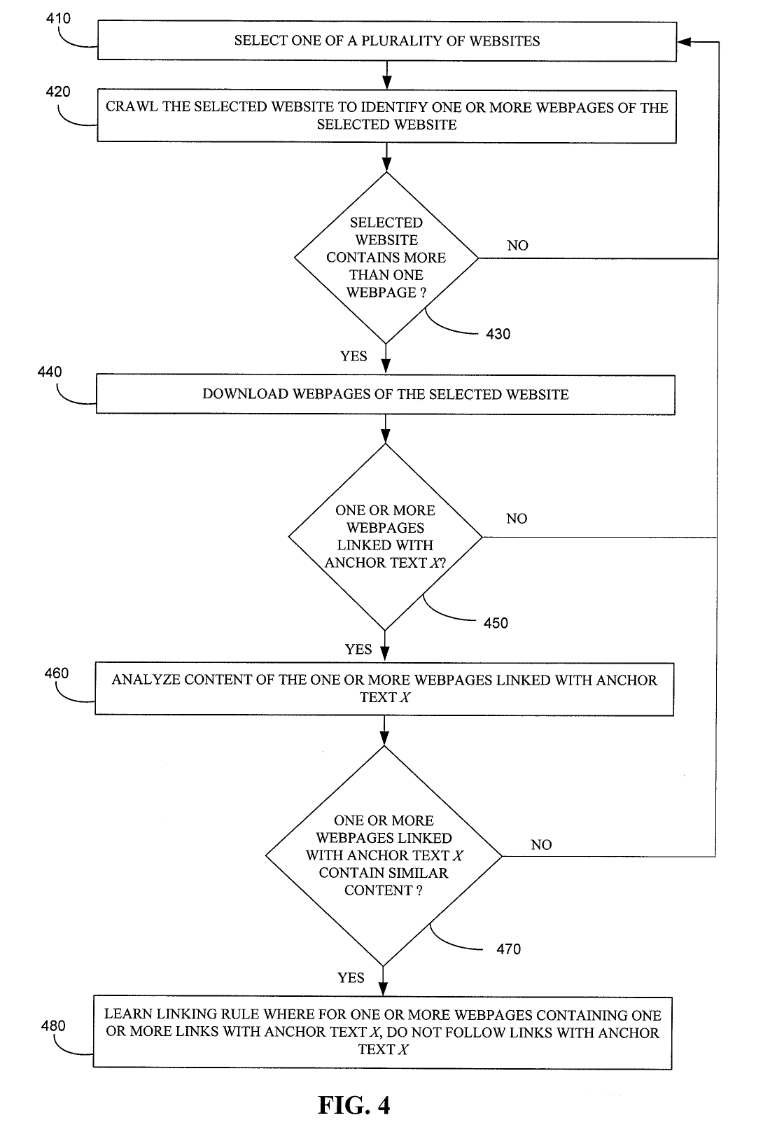

FIG. 4 illustrates a flow diagram presenting a method for learning one or more linking rules for detecting different content items with similar content by examining the anchortext of the links between the different content items according to one embodiment of the present invention. In accordance with the embodiment of FIG. 4, the method may begin by selecting one of a plurality of websites, step 410. For example, the website located at the URL http://news.yahoo.com/ (“Yahoo news website”). The selected website is then crawled to identify one or more content items, step 420. A determination is then made as to whether the selected website contains more than one webpage, step 430. For example, the Yahoo news website contains multiple content items containing separate news articles. A crawling engine may determine that the selected website contains only one webpage, causing program flow to return to step 410. If more than one webpage does exist, then the content items of the selected website are downloaded, step 440.

A determination is then made as to whether one or more content items are linked with anchortext X, step 450, e.g., “printer friendly version”. A detection engine may determine that one or more content items are not linked with anchortext X, causing program flow to return to step 410. If one or more content items are linked with anchortext X, the content of the one or more content items is analyzed, step 460. For example, the Yahoo news website may contain a webpage which contains a news article titled, “House OKs bill to prosecute contractors”. The webpage may contain a link to a second webpage on the website that comprises a printer-friendly version of the same news article. The link on the first webpage to the print version on the second webpage may be associated with the anchortext “print version”.

A determination is then made as to whether the content items linked by anchortext X comprise similar or identical content to the one or more source pages, step 470. A detection engine may determine that one or more content items linked with anchortext X do not comprise similar or identical content, causing program flow to return to step 410. If one or more content items linked with anchortext X do contain similar content, e.g., a number of content items exceeding a threshold, a linking rule may be learned whereby for one or more content items containing one or more links with anchortext X, links with anchortext X should not be followed during any subsequent crawling processes, step 480. Accordingly, where the number of identical or nearly identical content items that are linked with anchortext X exceeds a threshold, such as a percentage of content items, the rule may be deemed valid. For example, the webpage which comprises the news article entitled, “House OKs bill to prosecute contractors” on the Yahoo news website contains the same content as the second webpage on the Yahoo news website which contains the printer friendly version of the news article. Therefore, as the first and second content items are linked by the anchortext “print version”, a linking rule is determined that content items that are linked to with the anchortext “print version” should not be crawled by the search provider for inclusion in an index data store.

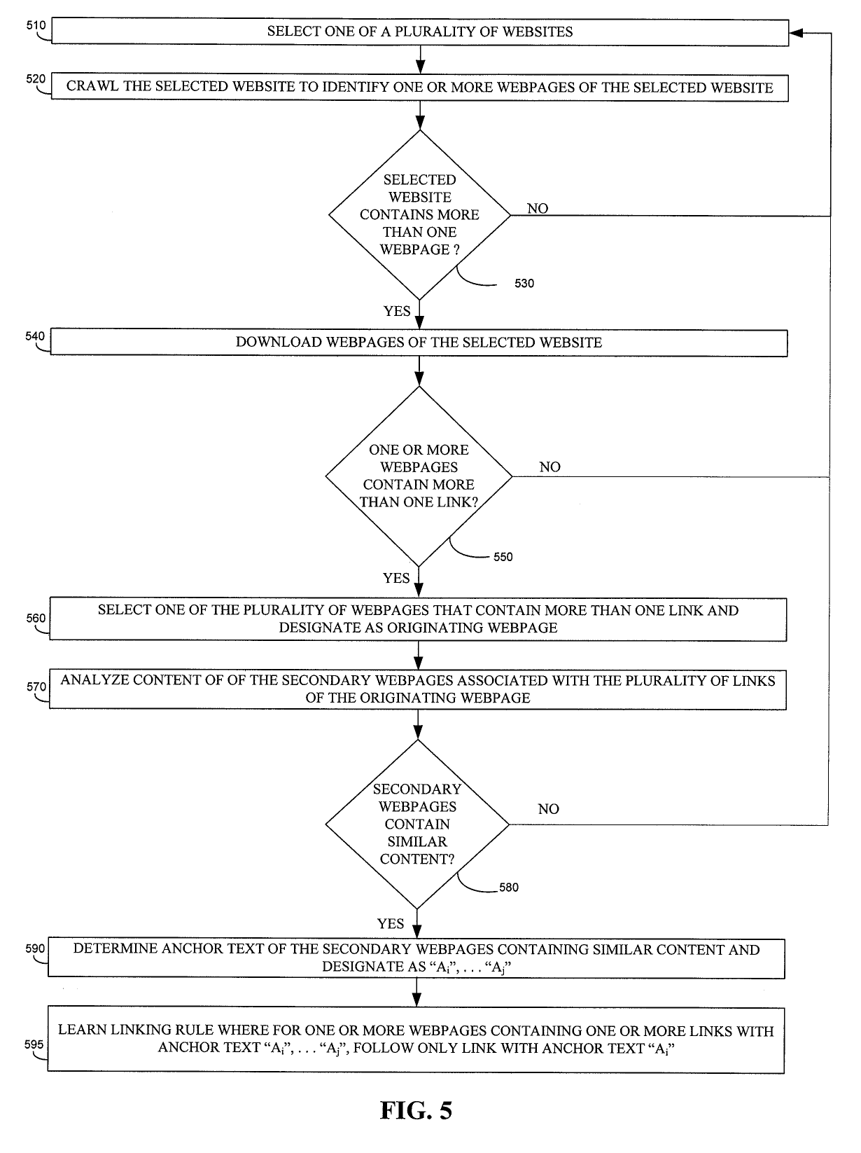

FIG. 5 illustrates a flow diagram presenting a method for learning one or more linking rules for detecting different content items with similar content by examining the anchortext of the link according to another embodiment of the present invention. In accordance with the embodiment of FIG. 5, the method may begin by selecting one of a plurality of websites, step 510, e.g., the Yahoo news website located at the URL, http://news.yahoo.com/.

The selected website may be crawled to identify one or more content items, step 520. A determination may also be made as to whether the selected website comprises more than one webpage, step 530. A crawling engine may determine that the selected website contains only one webpage, causing program flow to return to step 510. If more than one webpage does exist, then the content items of the selected website may be downloaded, step 540. A determination is made as to whether one or more content items comprise more than one link, step 550. A detection engine may determine that one or more content items do not contain more than one link, causing program flow to return to step 510. If one or more content items do contain more than one link, one of the content items containing more than one link is selected and designated as an originating webpage, step 560. For example, the webpage which contains the news article titled, “House OKs bill to prosecute contractors” on the Yahoo news website contains more than one link and may be designated as the originating webpage.

Secondary content items associated with the plurality of links of the originating webpage are then identified and the content of the secondary content items is analyzed, step 570. A determination is then made as to whether the secondary content items contain similar or identical content to the originating webpage, step 580. For example, one webpage that is linked to from the originating webpage which contains the news article titled, “House OKs bill to prosecute contractors” may be an Adobes Portable Document Format (“PDF”) version of the news article and a second webpage that is linked to from the originating webpage may be a HyperText Markup Language (HTML) version of the news article. Both the PDF and HTML versions of the news article would contain the same content, but only presented in different electronic formats.

A detection engine may determine that the secondary content items do not contain similar content, causing program flow to return to step 510. If the secondary content items do contain similar content, the anchortext of links that link the originating content item to the secondary content items containing similar or identical content is determined and designated as “Aᵢ, . . . , Aⱼ”, step 590. For example, the secondary content items which contain the PDF and HTML versions of the news article contain the same content as the originating webpage which contains the news article titled, “House OKs bill to prosecute contractors” on the Yahoo news website. The anchortext of the links to the secondary content items which contain the PDF and HTML versions of the news article is determined as “pdf” and “html”, respectively. The anchortext “pdf” may then be designated as “Aᵢ” and the anchortext “html” may be designated as “Aⱼ”.

A linking rule may then be learned where for one or more content items containing one or more links with anchortext Aᵢ, . . . , Aⱼ, follow only the link with anchortext Aᵢ when crawling, step 595. Continuing from the previous example, a linking rule may be determined that where content items that are linked to with the anchortext “pdf” as well as with the anchortext “html”, only content items that are linked to with the anchortext “pdf” should be retrieved or otherwise analyzed during the crawling process for storage in an index data store. Alternatively, or in conjunction with the foregoing, link proximity may be included in learning the linking rule.

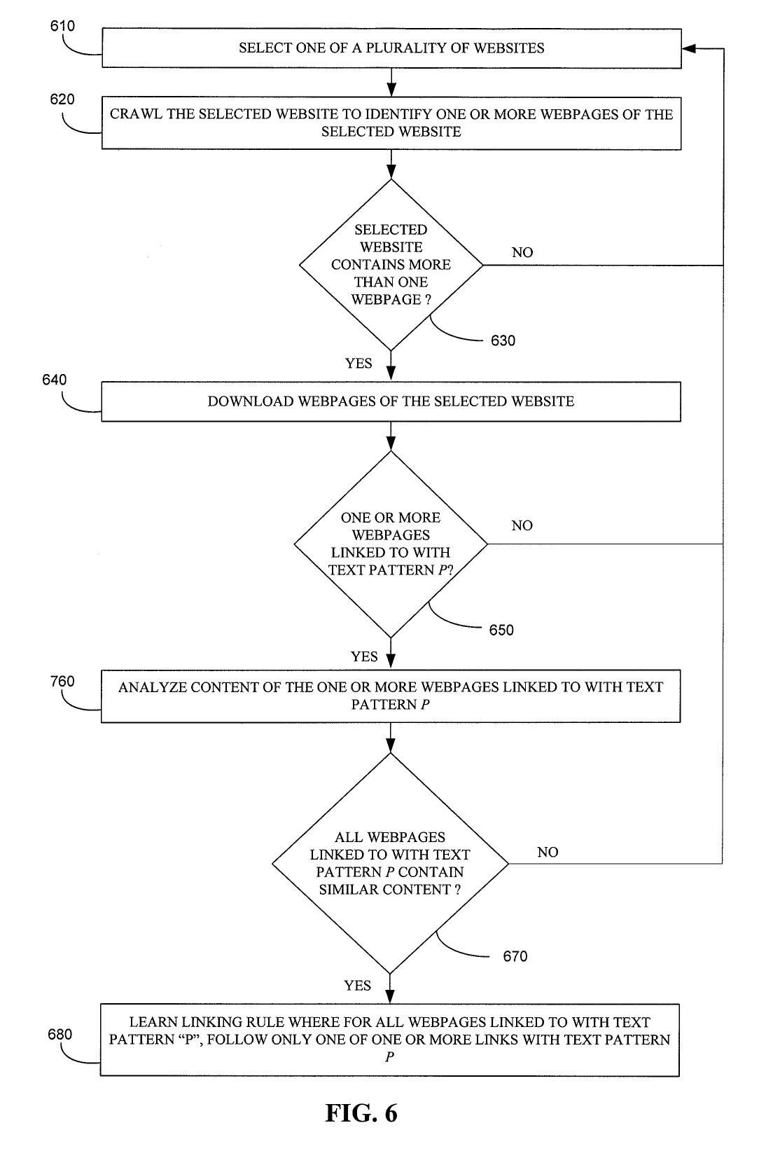

FIG. 6 illustrates a flow diagram presenting a method for learning one or more linking rules for detecting different content items with similar content by examining the anchortext of links between the different content items according to another embodiment of the present invention. In accordance with the embodiment of FIG. 6, the method may begin by selecting one of a plurality of websites, step 610, continuing from the previous example, the Yahoo news website located at the URL, http://news.yahoo.com/.

The selected website may be crawled to identify one or more content items, step 620. A determination may then be made as to whether the selected website contains more than one webpage, step 630. A crawling engine may determine that the selected website contains only one webpage, causing program flow to return to step 710. If more than one webpage does exist, then the content items of the selected website are downloaded, step 640. A determination is then made as to whether one or more content items are linked to with anchortext that comprises pattern P, step 650.

A detection engine may determine that one or more content items are not linked to with pattern P, causing program flow to return to step 610. If one or more content items are linked with to with pattern P, the content of the one or more content items is analyzed, step 660. For example, a web site that provides a list of mirrors to a main web site may be reviewed.

A determination is then made as to whether all the content items linked to with pattern P comprise similar or identical content, step 670. A detection engine may determine that a threshold number, percentage, etc. of content items linked to with anchortext comprising pattern P do not comprise similar or identical content, causing program flow to return to step 610. If a threshold number of content items (e.g., a percentage of content items) linked to with pattern P do contain similar or identical content, a linking rule may be learned whereby for content items linked to with pattern P, only one of the links anchortext comprising pattern P is followed, step 680. For example, where a threshold number of links to content items on a mirror site contain similar or identical content to a main content item for which the mirror site is providing copies, a linking rule may be learned whereby only one, or none, of the content items linked to from the mirror is crawled for inclusion in the index data store.

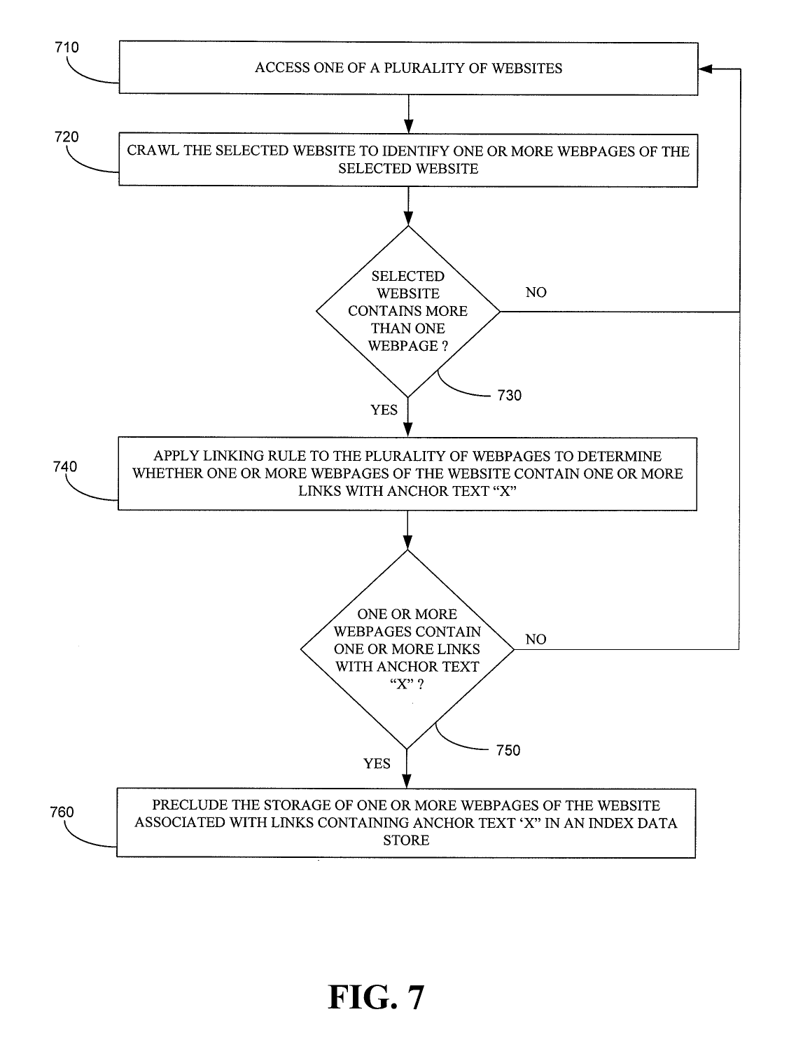

FIG. 7 illustrates a flow diagram presenting a method for applying one or more linking rules for detecting different content items with similar content by examining the anchortext of the link between the different content items according to one embodiment of the present invention. In accordance with the embodiment of FIG. 7, the method may begin by accessing one of a plurality of websites, step 710. The website is then crawled to identify one or more content items of the selected website, step 720. A determination is then made as to whether the selected website contains more than one webpage, step 730. A crawling engine may determine that the selected website contains only one webpage, causing program flow to return to step 710. If more than one webpage does exist, then a linking rule may be applied to the plurality of content items to determine whether one or more content items of the website contain one or more links with anchortext X, step 740. For example, the linking rule is applied such that content items that are linked to with the anchortext “print version” are not included in the index.

A determination is then made as to whether one or more content items contain one or more links with anchortext X, step 750. A detection engine may determine that one or more content items do not contain a link with anchortext X, causing program flow to return to step 710. If one or more content items do contain one or more links with anchortext X, the storage of the one or more content items of the website associated with the links containing anchortext X in an index data store is precluded, step 760, while maintaining storage of one copy in the index data store.

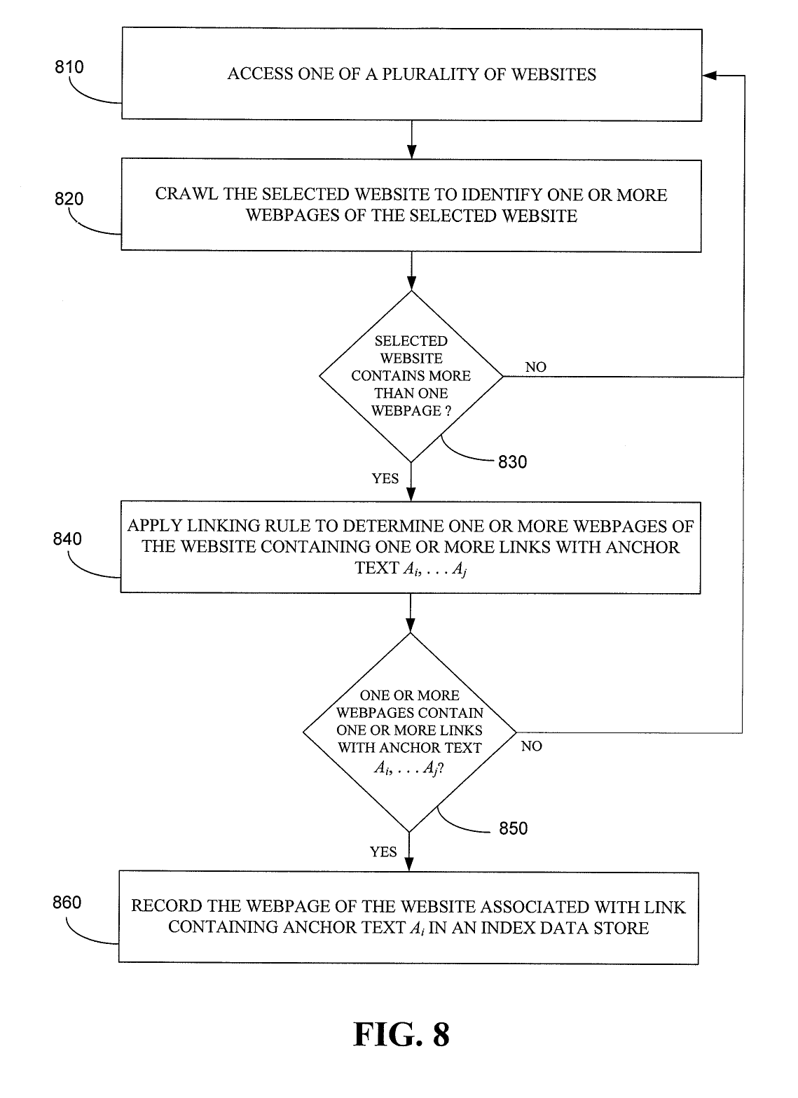

FIG. 8 illustrates a flow diagram presenting a method for applying one or more linking rules for detecting different content items with similar content by examining the anchortext of the link according to another embodiment of the present invention. In accordance with the embodiment of FIG. 8 the method may begin by accessing one of a plurality of websites, step 810. The website may be crawled to identify one or more content items of the selected website, step 820, and a determination made as to whether the selected website comprises more than one webpage, step 830. A crawling engine may determine that the selected website comprises only one webpage, causing program flow to return to step 810. If more than one webpage does exist, then a linking rule is applied to the plurality of content items to determine whether one or more content items of the website contain one or more links with anchortext Aᵢ, . . . Aⱼ, step 840. For example, for a linking rule where content items are linked to with the anchortext “pdf” and “html”, only content items that are linked to with the anchortext “pdf” should included in an index.

A determination is then made as to whether one or more content items contain one or more links with anchortext Aᵢ, . . . Aⱼ, step 850. A detection engine may determine that one or more content items do not contain a link with anchortext Aᵢ, . . . Aⱼ, causing program flow to return to step 810. If one or more content items contain one or more links with anchortext Aᵢ, . . . Aⱼ, the content item of the website associated with the link containing anchortext Aᵢ is recorded in the index, step 860.

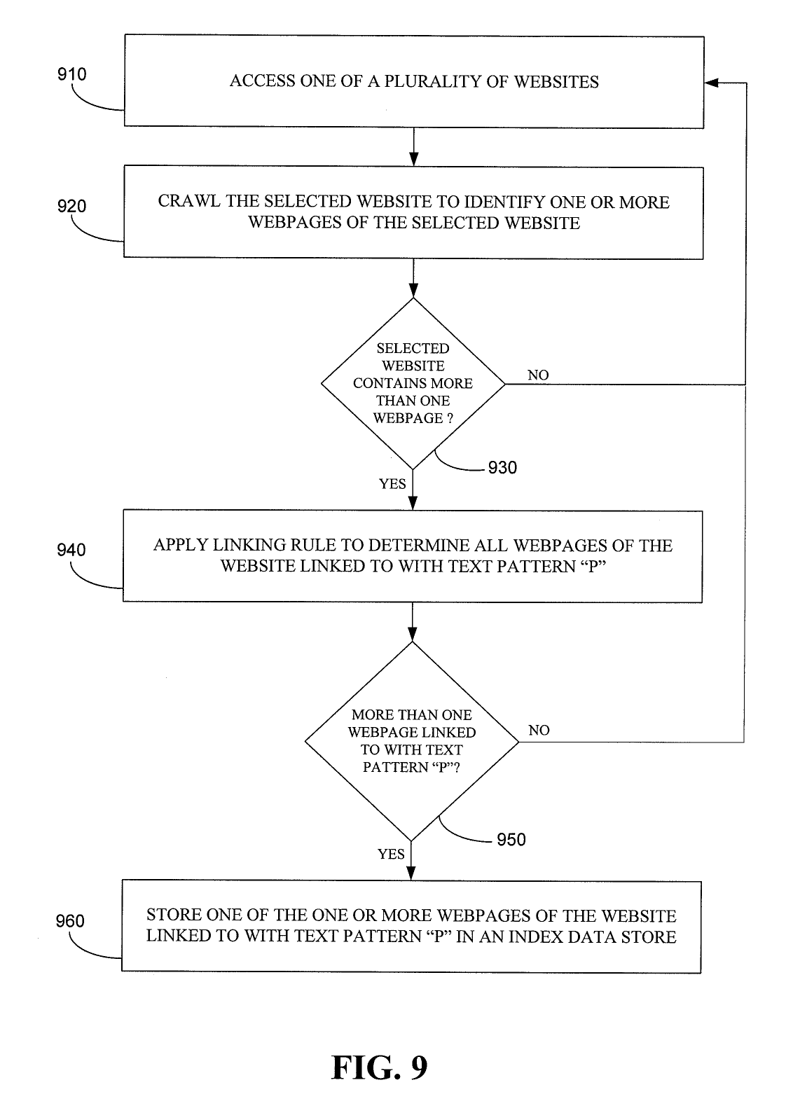

FIG. 9 illustrates a flow diagram presenting a method for applying one or more linking rules for detecting different content items with similar content by examining the anchortext of the links between the different content items according to another embodiment of the present invention. In accordance with the embodiment of FIG. 9, the method may begin by accessing one of a plurality of websites, step 910. The website is then crawled to identify one or more content items comprising the selected website, step 920. A determination may also be made as to whether the selected website comprises more than one webpage, step 930. A crawling engine may determine that the selected website comprises only one webpage, causing program flow to return to step 910. If more than one webpage does exist, then a linking rule is applied to the plurality of content items to determine content items comprising the website are linked with the pattern P, step 940. For example, where applying a linking rule where content items that are linked to from the list of links under the title “Today's Traffic”, only one of the content items linked to with the same pattern should included in the index in an index data store.

A determination is then made as to whether more than one webpage is linked to with anchortext comprising pattern P, step 950. A detection engine may determine that more than one webpage are not linked to with anchortext comprising pattern P, causing program flow to return to step 910. If more than one webpage is linked to with anchortext comprising pattern P, only one of the content items of the website associated with the link containing pattern P is stored, step 960, e.g., the content item comprising the link with anchortext comprising pattern P, but not the content item to which the link points.

In another embodiment of the present invention, determination of similar content can be extended to determinations in alternate languages. Specifically, in any of one of the rules previously described, determining similar or identical content is not limited to determining similar or identical content in a single language, but could extend to determining similar content in different languages, for example, where content item A is a French language version of content item B. According to some embodiments, all versions of a content item may be retrieved, recording relationships between the content items, thereby allowing a search engine to return one appropriate content item or a plurality of alternative content items.

FIGS. 1 through 9 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for detecting different content items with similar content, the method comprising:
selecting one of a plurality of websites;
crawling the selected website to identify one or more content items of the selected website;
downloading one or more content items of the selected website;
learning one or more linking rules based upon association rule by mining linking relationships between the one or more content items of the selected website; and
applying the one or more linking rules to one or more content items of one or more websites.

2. The method of claim 1 comprising precluding storage of a given content item of the one or more websites on the basis of the one or more linking rules.

3. The method of claim 1 comprising storing one or more content items of the one or more websites on the basis of the one or more linking rules.

4. The method of claim 1 wherein learning one or more linking rules comprises determining similar content among one or more content items of the selected website.

5. The method of claim 4 wherein learning one or more linking rules comprises learning a linking rule where for one or more content items linked to by a link containing anchortext X, the one or more content items are not stored.

6. The method of claim 3 wherein learning one or more linking rules comprises learning a linking rule where for one or more content items linked to by one or more links with anchortext Aᵢ, . . . Aⱼ, only the webpage linked to with anchortext Aᵢ is stored.

7. The method of claim 3 wherein learning one or more linking rules comprises a linking rule where for all content items linked to by anchortext with a pattern P, only one of the content items linked to with pattern P is stored.

8. Computer readable media comprising program code that when executed by a programmable causes execution of a method for detecting different content items with similar content, the computer readable media comprising:
program code for selecting one of a plurality of websites;
program code for crawling the selected website to identify one or more content items of the selected website;
program code for downloading one or more content items of the selected website;
program code for learning one or more linking rules based upon association rule by mining linking relationships between the one or more content items of the selected website; and
program code for applying the one or more linking rules to one or more content items of one or more websites.

9. The computer readable media of claim 8 comprising program code for precluding storage of the one or more content items of the one or more websites based upon the one or more linking rules.

10. The computer readable media of claim 8 comprising program code for storing one or more content items of the one or more websites based upon the one or more linking rules.

11. The computer readable media of claim 8 wherein program code for learning one or more linking rules comprises program code for determining similar content among one or more content items of the selected website.

12. The computer readable media of claim 8 wherein the program code for learning one or more linking rules comprises program code for a linking rule where for one or more content items linked to by a link containing anchortext X, the one or more content items are not stored.

13. The computer readable media of claim 8 wherein the program code for learning one or more linking rules comprises program code for a linking rule where for one or more content items linked to by one or more links with anchortext Aᵢ, . . . Aⱼ, only the webpage linked to with anchortext Aᵢ is stored.

14. The computer readable media of claim 8 wherein the program code for learning one or more linking rules comprises program code for learning a linking rule where for all content items linked to by anchortext with a pattern P, only one of the content items linked to with pattern P is stored.

15. A system for detecting different content items with similar content, the system comprising:
a central server operative to select one of a plurality of websites;
a crawling engine operative to:
crawl the selected website to identify one or more content items of the selected website, and
download one or more content items of the selected website;
a learning engine operative to:
determine one or more linking relationships from the one or more content items of the selected website; and
learn one or more linking rules based upon association rule mining of the one or more content items of the selected website; and
a detection engine operative to apply the one or more linking rules to one or more content items of one or more websites.

16. The system of claim 15 wherein the detection engine is operative to preclude storage of the one or more content items of the one or more websites on the basis of the one or more linking rules in an index data store.

17. The system of claim 15 wherein the detection engine is operative to store information regarding one or more content items in an index data store on the basis of the one or more linking rules.

18. The system of claim 15 wherein the crawling engine is operative to determine one or more linking rules by determining one or more linking relationships in order to determine similar content among one or more content items.

19. The system of claim 15 wherein the detection engine is operative to apply a linking rule where for one or more content items linked to by a link containing anchortext X, the one or more content items are not stored.

20. The system of claim 15 wherein the detection engine is operative to apply a linking rule where for one or more content items linked to by one or more links with anchortext Aᵢ, . . . Aⱼ, only the webpage linked to with anchortext Aᵢ is stored.

21. The system of claim 15 wherein the detection engine is operative to apply a linking rule where for one or more content items linked to by a pattern P, only one of the content items linked to anchortext with pattern P is stored.
